(19) United States
(12) Patent Application Publication
(10) Pub. No.: US 2007/0125709 A1
(43) Pub. Date: Jun. 7, 2007

(54) Extracorporeal Renal Dialysis System

(76) Inventor: Alok Nigam, Trabuco Canyon, CA (US)

Correspondence Address: KIRKPATRICK & LOCKHART PRESTON GATES ELLIS LLP, 1900 MAIN STREET, SUITE 600, IRVINE, CA, 92614-7319, US

(21) Appl. No.: 11/469,538

(22) Filed: Sep. 1, 2006

Related U.S. Application Data
(60) Provisional application No. 60/714,028, filed on Sep. 2, 2005.

(51) Int. Cl. B01D 61/00

(52) U.S. Cl. 210/645; 210/646; 210/96.2; 210/134; 210/143; 210/321.72; 210/259

(57) ABSTRACT

The present invention provides an extracorporeal renal dialysis system including a recirculating dialysis apparatus and at least one detoxification cartridge wherein the system can be used for either hemodialysis or peritoneal dialysis requiring small volumes of dialysate.

### CROSS-REFERENCE TO RELATED APPLICATIONS

The present invention claims the benefit under 35 U.S.C. §119(e) to U.S. Provisional Application No. 60/714,028 filed Sep. 2, 2005

### FIELD OF THE INVENTION

The present invention relates to devices and methods for the out-patient treatment of kidney failure using dialysis.

### BACKGROUND OF THE INVENTION

The National Institute of Health (NIH) reports that more than 289 people per million population in the United States require renal replacement therapy in the form of dialysis. The main barriers to treating dialysis patients have been expense and practicality. Moreover, the largest portions of the world's population live in countries that do not support dialysis. Patients in those areas who need dialysis must pay for their own treatment, which leads to a sparing use of material that results in serious under dialysis and ineffective treatment. In the United States, while the expenses are reimbursed by insurance or federal assistance programs, the need for the patient to drive to a dialysis center for treatment, often over long distances, is a serious barrier to obtaining dialysis treatment for some needy patients. Furthermore, in countries where there are few dialysis patients there is no highly trained and dedicated staff to care for the patients' special needs. In short, the high cost of the current dialysis methods, massive supplies that must be delivered and stored for home dialysis, inadequate transportation, and a lack of trained professional healthcare workers capable of delivering dialysis treatment, are serious obstacles for dialysis patients.

There are two methods of clinical dialysis in widespread use today, hemodialysis and peritoneal dialysis. They differ in the method by which the patient's blood is exposed to the dialysate. Hemodialysis is the most widely used type of clinical dialysis in which the patient's blood is taken outside the body and passed through a dialysis cell, called a hemodialyzer. The hemodialyzer includes a membrane. The patient's blood flows on a sterile side of the membrane while the dialysate flows along the opposite side. Dialysis of blood toxins and excess water occurs across the membrane. This process uses large amounts of dialysate, typically approximately 150 liters per session. Hemodialysis also requires the assistance of trained personnel and subjects the patient to the dangers of mechanical malfunction, rapid shifts of fluid and metabolite, and surgery associated with attaching an artery directly to a vein to produce an adequate blood flow for dialysis treatment.

Peritoneal dialysis was developed as a means of surmounting some of the difficulties associated with in-center hemodialysis. In addition, peritoneal dialysis is more suitable for in home use. In peritoneal dialysis, a specially prepared, sterilized dialysis fluid (dialysate) is instilled into the peritoneal cavity through an in-dwelling dialysis catheter and the peritoneal membrane acts as the dialysis membrane. Toxins from the blood move down the gradient, across the peritoneal membrane and into the dialysate, freeing the body of toxins. The dialysate is allowed to remain in the peritoneal space for a period of time in order to maximize the quantity of toxins removed per unit volume of dialysate. Then, after absorbing body toxins in a long slow process, the dialysis fluid is removed and discarded. However, the longer the fluid remains in the cavity the less effective it becomes at removing waste due to the shift in the gradient towards equilibrium. Thus, the dialysate is typically allowed to reside in the peritoneal cavity for two hours at a time. The process is then repeated until the level of toxic metabolites in the blood is reduced to a desired level. Typically four to five exchanges of dialysate are performed per treatment session. This method requires that multiple bags of fresh, sterilized dialysis solution are constantly exchanged to provide the supply of fresh, sterilized dialysate with an acceptable osmotic gradient.

Accordingly, in order to increase the efficiency of peritoneal dialysis by decreasing the volume of dialysate, several novel peritoneal dialysis systems have been developed. U.S. Pat. No. 5,141,493 discloses a peritoneal dialysis system comprising a primary circuit carrying a primary dialysis solution to the peritoneal cavity of a patient, withdrawing at least some solution from the patient into the primary circuit through a dialyzer to remove of waste products from the primary dialysis solution to a secondary dialysis solution. The peritoneal dialysis fluid withdrawn from the peritoneal cavity of the patient is purified sequentially through the dialyzer and returned again into the cavity of the patient.

U.S. Pat. No. 5,641,405 discloses a system including a a single catheter, a source of peritoneal dialysis fluid, a dialyzer and a single reversible pump positioned between the source of peritoneal dialysis fluid and the catheter. In this arrangement, the dialysate is pumped into the peritoneal cavity and, after a period of time, out of the peritoneal cavity, through the dialyzer and back to the source of dialysate. Over time non-dialyzed toxins accumulate in the dialysate rendering it less effective at removing toxins from the blood. After the initial fill of the peritoneal cavity with fresh dialysate, subsequent dialysate contains increasing concentrations of waste products not removed by the dialyzer.

Spent dialysate contains large molecular weight proteins, primarily albumin (an essential protein for maintaining good health and nutrition), that have been released into the dialysate liquid through the peritoneal membrane during the peritoneal dialysis cycle. These essential components of the peritoneal dialysate fluid are lost when the dialysate fluid is discarded and the patient has to compensate for the loss of these proteins by intensified protein synthesis. As a result, approximately 50% of the patients on peritoneal dialysis suffer from malnutrition. One advantage of the reuse of the dialysate liquid as described in U.S. Pat. Nos. 5,141,493 and 5,641,405 is that the removal of small and middle molecular weight toxic molecules, as well as protein-bound toxins, while sparing the albumin and related essential proteins from the dialysate and reuse of the thus-purified dialysate would significantly reduce further loss of these proteins due to a diminished concentration gradient between the dialysis liquid and the blood with respect to these proteins.

However, the prior art dialysate recirculation systems only remove a small amount of the waste toxins present in the spent dialysate. Therefore with each successive re-use, the amount of these toxins in the dialysate increases and the effectiveness of dialysis decreases.

Therefore there exists a medical need for renal dialysis systems that can regenerate spent dialysis fluid by removing the majority of the toxic waste products which accumulate therein, for both hemodialysis and peritoneal dialysis systems, in order to provide patients with improved renal dialysis systems that require the smaller quantities of dialysis fluid essential in out-patient dialysis environment.

### SUMMARY OF THE INVENTION

The present invention relates to improved devices and methods for renal dialysis using reduced quantities of fresh dialysate. An extracorporeal renal dialysis system is provided comprising a recirculating dialysis apparatus and at least one detoxification cartridge. The present inventor has determined that dialysate, from either hemodialysis or peritoneal dialysis, can be recirculated, during the dialysis session, e needed by passing the spent dialysate through a detoxification cartridge before returning the detoxified dialysate to use thereby reducing the volume of fresh dialysate needed. The extracorporeal renal dialysis system of the present invention removes waste toxins yet spares many normal essential molecules that are often lost during standard dialysis methodologies. More specifically the present invention provides a detoxification cartridge which is attached aseptically and releasably to a portable recirculating dialysis apparatus for the detoxification of spent dialysis fluid. The detoxification cartridge is comprised of at least one substrate, each substrate comprising at least one material which specifically removes a class of toxic waste molecules from the spent dialysate. By removing a broad range of toxic waste molecules from the spent dialysate, the dialysate has, in effect, been regenerated and can be recirculated for more efficient use of relatively small quantities of dialysate.

The extracorporeal renal dialysis system of the present invention provides a more effective dialysis treatment for the patient in that it does not remove essential molecules, including high-molecular weight proteins such as albumin, which are necessary for maintaining the health of the patient, and does remove small molecular weight species such as excess phosphates and salts, middle molecular weight toxins and protein-bound toxins, which are not removed by standard hemodialysis or peritoneal dialysis systems. Additionally the extracorporeal renal dialysis system of the present invention provides dialysis patients a portable dialysis system which uses less dialysate than standard dialysis systems, making home dialysis accessible for more dialysis patients.

The extracorporeal renal dialysis system of the present invention is designed to be used with standard dialysis accessories containing access ports, catheters, tubing and connections which are well known to those skilled in the art. The extracorporeal renal dialysis system of the present invention easily and reversible connects to these standard components and therefore does not require the patient to have any additional invasive procedures to use the apparatus or cartridge of the present invention.

In one embodiment of the extracorporeal renal dialysis system of the present invention, the toxin removal device comprises materials that remove protein-bound toxins, low molecular weight organic molecules, excess phosphate, excess salt, and middle molecular weight toxins.

In another embodiment of the extracorporeal renal dialysis system of the present invention, the apparatus further comprises an optional fluid removal device.

In one embodiment of the present invention, an extracorporeal renal dialysis system is provided comprising a recirculating dialysis apparatus and at least one detoxification cartridge. In another embodiment, the dialysis is peritoneal dialysis or hemodialysis.

In another embodiment of the present invention, the recirculating dialysis apparatus can provide one-pass dialysis or recirculating dialysis. In another embodiment, the recirculating dialysis apparatus comprises a device for regulating the flow of a fluid in need of toxin removal from a renal dialysis patient, through a dialysis cassette and returning the fluid to the renal dialysis patient.

In yet another embodiment of the present invention, the dialysis cassette comprises a first chamber and a second chamber, wherein the first chamber and the second chamber are separated by a dialysis membrane. In another embodiment, the dialysis membrane has a molecular weight cut-off of approximately 1,000 daltons to approximately 100,000 daltons. In another embodiment, the dialysis membrane has a molecular weight cut-off of approximately 5,000 daltons.

In another embodiment of the present invention, the first chamber comprises a first port for fluid in need of detoxification to pass from the patient into the first chamber of the dialysis cassette and a second port for detoxified fluid to pass from the first chamber of the dialysis cassette to the patient. In another embodiment, the second chamber contains dialysis fluid. In another embodiment, the second chamber comprises a first port for spent dialysis fluid to pass from the second chamber of the dialysis cassette to the detoxification cartridge and a second port for regenerated dialysis fluid to pass from the detoxification cartridge into the second chamber of the dialysis cassette.

In another embodiment of the present invention, the detoxification cartridge comprises at least one substrate containing at least one toxin-removal material selected from the group consisting of cross-linked micro- or macro-porous matrices, activated carbon, phosphate binding agents, ion exchangers, hollow fiber filters and membrane filters.

In another embodiment of the present invention, the flow of fluid through said dialysis cassette and said detoxification cartridge is one-way. In another embodiment of the present invention, the extracorporeal renal dialysis system further comprises a water removal cassette.

In one embodiment of the present invention, a recirculating dialysis apparatus is provided comprising at least one pump; at least one flow regulator; at least one leak detector; at least one pressure regulator; at least one connecting port for attaching a dialysis cassette; a heating system to maintain a constant temperature of toxin-containing fluids and dialysate; a pH regulating system; an in-line sterilization system; a microprocessor; a communication system to link said microprocessor with a healthcare professional; a detoxification cartridge loading system; and a cartridge port sterilizing system.

In another embodiment of the present invention, the recirculating dialysis apparatus further comprises a detoxification cartridge. In another embodiment, the cartridge port sterilization system comprises an ultraviolet light to terminally sterilize the engaged cartridge ports. In yet another embodiment, the microprocessor monitors the performance of said renal dialysis apparatus and generates performance data. In another embodiment, the microprocessor transmits said performance data to a remote site. In another embodiment, the remote site is a doctor's office or a dialysis center. In yet another embodiment, the microprocessor transmits through a wireless connection.

In yet another embodiment of the present invention, the recirculating dialysis apparatus releasably engages at least one detoxification cartridge at a sterile cartridge port. In another embodiment, the recirculating dialysis apparatus can provide one-pass dialysis or recirculating dialysis. In another embodiment, the recirculating dialysis apparatus further comprises an optional water removal device.

In one embodiment of the present invention, a detoxification cartridge is provided comprising at least two ports suitable for aseptically and releasably connecting the detoxification cartridge to a recirculating dialysis apparatus; and at least one substrate.

In another embodiment of the present invention, the at least one substrate comprises at least one toxin-removal material selected from the group consisting of cross-linked micro- or macro-porous matrices, activated carbon, phosphate binding agents, ion exchangers, hollow fiber filters and membrane filters. In another embodiment, the cross-linked micro- or macroporous matrix is cross-linked gelatin or a synthetic polymer grafted with albumin. In another embodiment, the phosphate binding agent is selected from the group consisting of calcium carbonate, lanthanum carbonate, zirconium hydroxide and hydrated oxides of iron or aluminum. In yet another embodiment, the ion exchanger for the removal of excess salt is comprised of an ion exchange resin contained within a permeable membrane wherein contact between the ion exchange resin and spent dialysate is allowed only when the concentration of salt in said spent dialysate is more than 0.8%.

In another embodiment of the present invention, the hollow fiber filter or membrane filter has a molecular weight cutoff of less than approximately 50,000 daltons for the removal of middle molecular weight toxins. In another embodiment, the hollow fiber filter or membrane filter contains a polyaldehyde or a polyanhydride. In another embodiment, the polyaldehyde is oxidized starch.

In one embodiment of the present invention, a method is provided for reducing dialysate usage in renal dialysis, wherein said method defines one dialysis session, comprising circulating fluid in need of toxin removal from a renal dialysis patient through a first chamber of a dialysis cassette and back to the patient; allowing toxins from the fluid in need of toxin removal to pass through a dialysis membrane from said first chamber into a second chamber of the dialysis cassette, wherein the second chamber contains dialysis fluid; passing the dialysis fluid through a detoxification cartridge; detoxifying the dialysis fluid; and returning the fluid to the second chamber of the dialysis cassette. In another embodiment, the renal dialysis is peritoneal dialysis or hemodialysis. In yet another embodiment, the fluid in need of toxin removal is dialysate or blood. In another embodiment, the usage of fresh dialysis fluid is approximately one liter to approximately ten liters per dialysis session.

In one embodiment of the present invention, a method is provided for removing toxins from a patient undergoing renal dialysis comprising reacting a toxin-containing fluid from the patient with at least one substrate containing a material which removes a toxin from the fluid; and returning the toxin-depleted fluid to the patient. In another embodiment, the toxin-containing fluid is blood or dialysate.

In another embodiment of the present invention, the toxin is phosphate and the material is a phosphate binding agent selected from the group consisting of calcium carbonate, lanthanum carbonate, zirconium hydroxide and hydrated oxide of iron or aluminum.

In another embodiment of the present invention, the toxins are middle molecular weight toxins and the material is a hollow fiber filter or membrane filter. In another embodiment, the hollow fiber filter or membrane filter has a molecular weight cutoff of less than approximately 50,000 daltons for the removal of middle molecular weight toxins. In yet another embodiment, the hollow fiber filter or membrane filter contains a polyaldehyde or a polyanhydride. In another embodiment, the polyaldehyde is oxidized starch.

In another embodiment of the present invention, the toxin is a protein-bound toxin and the material is a cross-linked micro- or macroporous matrix selected from the group consisting of cross-linked gelatin or a synthetic polymer grafted with albumin.

### BRIEF DESCRIPTION OF THE DRAWINGS

FIG. 1 depicts an embodiment of a extracorporeal renal dialysis system of the present invention.

FIG. 2 depicts a schematic diagram of a detoxification circuit of the extracorporeal renal dialysis system of the present invention.

FIG. 3 depicts a detoxification cartridge of the extracorporeal renal dialysis system of the present invention.

FIG. 4 depicts a schematic diagram of the substrates within the interior of the detoxification cartridge.

### DETAILED DESCRIPTION OF THE INVENTION

The present invention relates to improved devices and methods for renal dialysis using reduced quantities of fresh dialysate. An extracorporeal renal dialysis system is provided comprising a recirculating dialysis apparatus and at least one detoxification cartridge. The present inventor has determined that dialysate, from either hemodialysis or peritoneal dialysis, can be recirculated during the dialysis session, by passing the spent dialysate through a detoxification cartridge before returning the detoxified dialysate to use thereby reducing the volume of fresh dialysate needed. The extracorporeal renal dialysis system of the present invention removes waste toxins yet spares many normal essential molecules that are often lost during standard dialysis methodologies. More specifically the present invention provides a detoxification cartridge which is attached aseptically and releasably to a portable recirculating dialysis apparatus for the detoxification of spent dialysis fluid. The detoxification cartridge is comprised of at least one chamber containing at least one substrate, each substrate comprising at least one material which specifically removes a class of toxic waste molecules from the spent dialysate. By removing a broad range of toxic waste molecules from the spent dialysate, the dialysate has, in effect, been regenerated and can be recirculated for more efficient use of relatively small quantities of dialysate.

A particular advantage of the extracorporeal renal dialysis system of the present invention is that it allows dialysis patients to conduct dialysis in environments which, prior to the discovery by the present inventor, were prohibitive in terms of logistics and infrastructure. The recirculating dialysis apparatus of the present invention is sized such that it is suitable for use in a home environment and can be transported with a patient when traveling. The extracorporeal renal dialysis system of the present invention significantly reduces the need for large volumes of fresh dialysate and eliminates the water purification infrastructure, or storage space for large quantities of bagged, sterile dialysate, currently required to perform hemodialysis or peritoneal dialysis in the home environment.

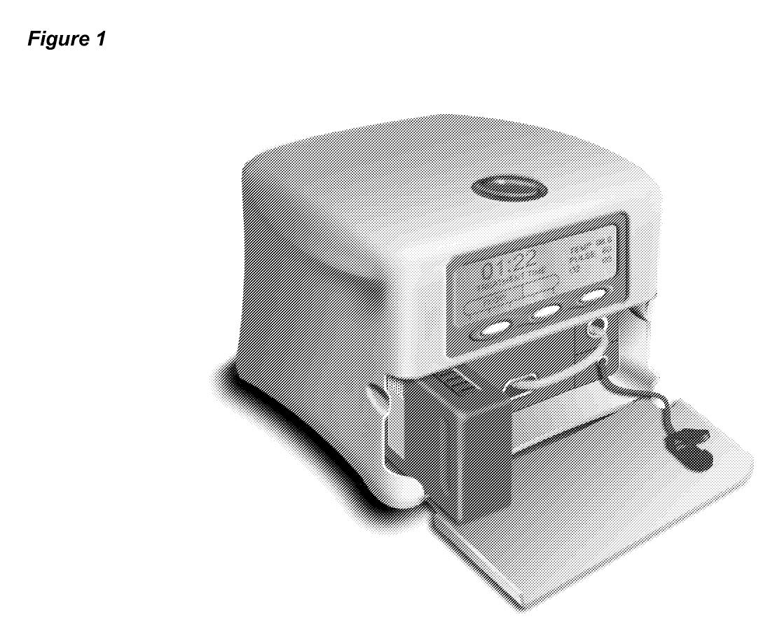

The extracorporeal renal dialysis system of the present invention is comprised of a recirculating dialysis apparatus and at least one detoxification cartridge as depicted in FIG. 1. The extracorporeal renal dialysis system of the present invention can be used for either hemodialysis or peritoneal dialysis, depending on the specific needs of the patient.

The recirculating dialysis apparatus of the present invention provides a housing having ports to aseptically connect a dialysis cassette and at least one detoxification cartridge along with such tubing and connections that may be necessary to perform dialysis. The recirculating dialysis apparatus also provides a system to monitor the progress of a dialysis session and the ability to send the monitoring data to a remote location, such as a hospital, physician's office or dialysis center, whereby the dialysis session can be monitored by a medical professional. The recirculating dialysis apparatus of the present invention also contains standard features as would be known to persons of ordinary skill such as electrical input, motors, pumps, temperature and pressure monitors, displays, tubing and sterilization systems. In another embodiment of the present invention the recirculating dialysis apparatus optionally contains ports for the aseptically and releasable connecting a water removal cartridge. In yet another embodiment of the present invention, the recirculating dialysis apparatus optionally contains an in-line sterilization filter to sterilize detoxified dialysis fluid before it returns to the dialysis cassette.

For further description of the composition and operation of extracorporeal renal dialysis system, the source of fluid for detoxification, blood or spent dialysate, is treated the same and therefore the term “toxin-containing fluid” will be used to refer to either blood or spent dialysate in need of detoxification.

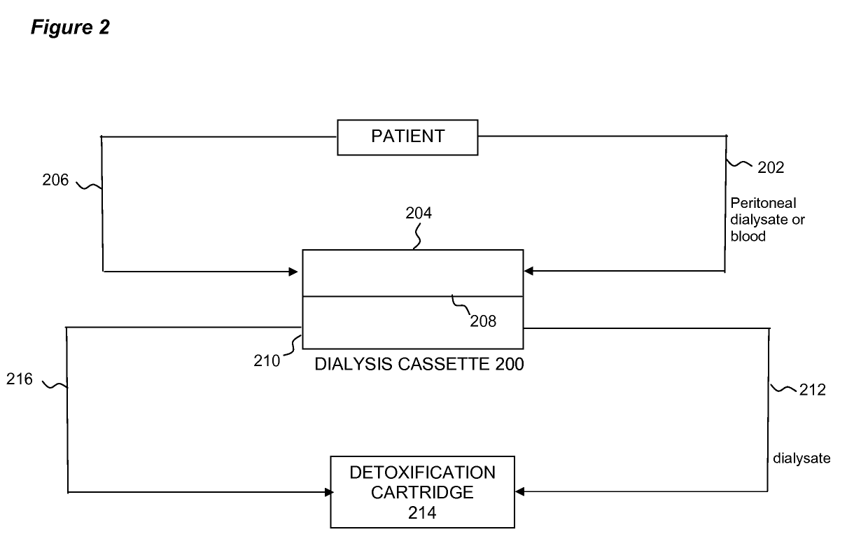

One embodiment of the flow of toxin-containing fluid through the extracorporeal renal dialysis system is depicted in FIG. 2. In this embodiment, a dialysis cassette 200 and a single detoxification cartridge 214 are used. The present invention provides ports for the aseptic and reliable connection of additional detoxification cartridges, optional water removal cartridges and an in-line sterilization filter.

As the toxin-containing fluid leaves the patient through route 202, it enters dialysis cassette 200 which is divided into a first chamber 204 and a second chamber 210 by a dialysis membrane 208. Biocompatible dialysis membranes suitable for use in the dialysis cassette of the present invention are known to persons of ordinary skill in the art and are commercially available. In one embodiment of the present invention, the dialysis membrane 208 has a molecular weight cut-off of 50,000 daltons such that molecules and particles larger than the 50,000 dalton pore size will remain in the fluid present in the first chamber 204 and molecules and particles smaller than the 50,000 dalton pore size pass through dialysis membrane 208 into second chamber 210. Dialysis membranes with larger or smaller pore sizes are suitable for use with the dialysis cassette of the present invention and the selection of a dialysis membrane of a particular molecular weight cut-off is determine by the health care provider based on the particular needs of a given patient. Preferably a dialysis membrane pore size is selected so that beneficial proteins present in the toxin-containing fluid, such as albumin, are retained and returned to the body while smaller and middle molecular weight toxins cross the dialysis membrane and are removed from the spent dialysis fluid by the detoxification cartridge.

Second chamber 210 contain dialysis fluid, which can be any of numerous commercially available dialysis fluids commercially available and know to persons of ordinary skill in the art.

Toxin-containing fluids from the patient, either blood or peritoneal dialysate, only enter the first chamber of the dialysis cassette and only fluids from the first chamber of the dialysis cassette return to the patient. The remaining portions of the recirculating dialysis apparatus and detoxification cartridge 214 are separated from the patient fluids by dialysis membrane 208.

Toxins present in the toxin-containing fluid will pass through the dialysis membrane based upon a concentration gradient of the toxins on either side of dialysis membrane 208. When the concentration of any given molecule in the toxin-containing fluid in first chamber 204 is higher than the concentration of the same molecule in the dialysis fluid in second chamber 210, then that molecule will pass from the toxin-containing fluid in first chamber 204 through membrane 208 into the dialysate in second chamber 210. If the toxin-containing fluid in first chamber 204 does not have a higher concentration of the given molecule than the dialysis fluid in second chamber 210, then that molecule will not pass through the dialysis membrane. Therefore standard dialysis fluids, including those suitable for use in the device of the present invention, contain concentrations of sugars, salts and proteins equivalent to the concentrations of the same molecules in normal blood or peritoneal fluid, such that these molecules are not removed or lost by the dialysis process.

After the toxin-containing fluid is detoxified by the passage of toxins from first chamber 204 into the dialysis fluid of second chamber 210, the detoxified fluid returns to the patient through route 206.

The present invention provides a secondary fluid flow which detoxifies the dialysis fluid from second chamber 210 by passing the dialysis fluid through a detoxification cartridge 214. Dialysate from second chamber 210 leaves second chamber 210 through route 212 and enters detoxification cartridge 214 containing at least one substrate containing at least one material to remove toxins from the dialysis fluid. Detoxified dialysis fluid leaves detoxification cartridge 214 and returns to second chamber 210 thereby restoring the favorable toxin concentration gradient which allows toxins to pass across the dialysis membrane 208 and be removed from the patient's toxin-containing fluid.

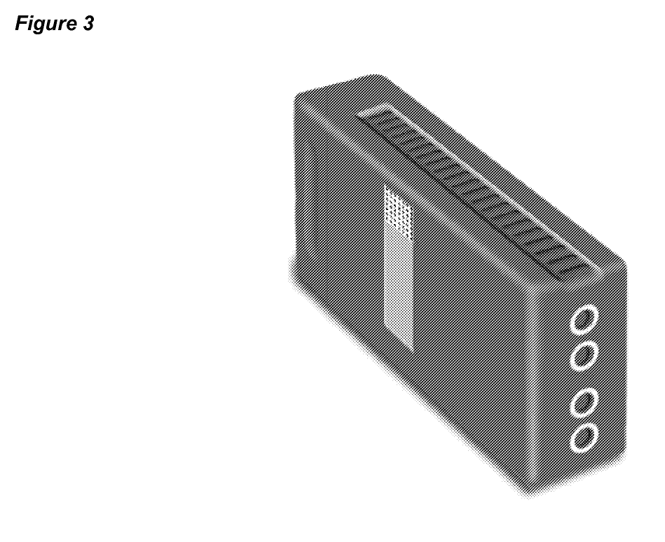

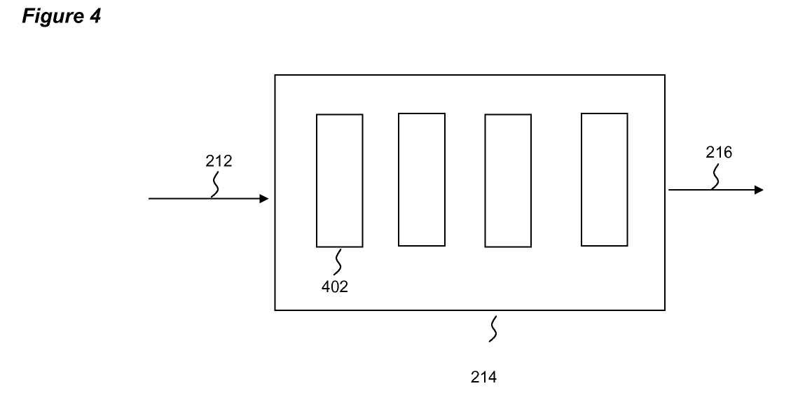

The detoxification cartridge 214 of the present invention is comprised of at least one substrate containing at least one material to remove toxins from a toxin-containing fluid, specifically a toxin-containing dialysis fluid. The detoxification cartridge is depicted in FIGS. 3 and 4. In an exemplary embodiment, FIG. 4 depicts a detoxification cartridge 214 which receives toxin-containing dialysis fluid from route 212. In this exemplary embodiment, detoxification cartridge 214 contain four substrates, each of which contain at least one material to remove toxins from a toxin-containing fluid. Other embodiments of detoxification cartridge 214 may have less than four substrates or more than four substrates.

Substrates can be arranged with the detoxification cartridge in any order or configuration necessary to include any and all toxin removal materials within the cartridge.

Materials useful in the removal of toxic molecules in the detoxification cartridge of the present invention include, but are not limited to, cross-linked micro- or macroporous matrices, activated carbon, phosphate binding agents, ion exchange resins, hollow fiber filters and membrane filters.

In one embodiment of the present invention, each of the at least one substrates in the detoxification cartridge of the present invention contain a different material to purify a specific toxin or class of toxins from toxin-containing dialysis fluid. In another embodiment of the present invention, each of the at least one substrates in the detoxification cartridge of the present invention contains a plurality of different materials to purify toxins or class of toxins from toxin-containing dialysis fluid.

Each substrate is comprised of a micro- or macroporous cross-linked protein matrix or other cross-linked matrix which each contains at least one material or device to remove a particular toxin or class of toxins from the spent dialysate. Each material can also be used in its native form, such as a granular or powder form, without being contained in a micro- or macroporous matrix. The micro- or macroporous matrix, in addition to providing a structural support for toxin-removing materials, removes protein-bound toxins from the toxin-containing dialysis fluid. Non-limiting examples of micro- or macroporous cross-linked protein matrices suitable for removing protein-bound toxins such as, but not limited to, cross-linked gelatin and synthetic or natural polymers with anhydride or aldehyde groups (such as, but not limited to, stearic maleic anhydride) attached thereto that can be bound with proteins that can exchange toxins bound to serum albumin and exchange them to the matrix. Each substrate can optionally have a dialysis membrane surrounding the substrate such that the dialysis membrane has a molecular weight cut-off sufficiently large to allow all toxins which have the potential to enter the substrate and be removed by the materials within the substrate into the substrate.

Protein-bound toxins removed by the detoxification cartridge of the present invention include, but are not limited to, homocysteine, indoxyl sulfate, hippuric acid, phosphate and others.

In another embodiment of the present invention, the substrate can be a polysaccharide matrix having anhydride or aldehyde functional groups (such as, but not limited to, oxidized starch, or aldehydes or anhydrides such as stearic maleic anhydride attached thereto) that can be bound with proteins that can exchange toxins bound to serum albumin and exchange them to the matrix.

In another embodiment of the detoxification cartridge of the present invention, one material to purify a specific toxin or class of toxins from toxin-containing dialysis fluid binds excess phosphate. Non limiting examples of phosphate binding agents suitable for removal of excess phosphate and inorganic phosphorus from biological fluids includes calcium carbonate, lanthanum carbonate, zirconium hydroxide and hydrated oxides of aluminum and iron. In another embodiment of the present invention, the phosphate binding agents are co-located in the same chamber with the cross-linked micro- or macroporous matrix or in the chamber containing a hollow fiber or membrane filter.

In an embodiment of the detoxification cartridge of the present invention, a material to purify a specific toxin or class of toxins from toxin-containing dialysis fluid contains activated carbon for the removal of low molecular weight organic molecules including, but not limited to, creatinine and urea.

In another embodiment of detoxification cartridge of the present invention, one substrate contains an ion exchanger for removal of excess salt from spent dialysate. An exemplary ion exchanger useful in the detoxification cartridge of the present invention removes salt from the spent dialysis fluid only when the concentration of salt is more than approximately 0.8%. The ion exchanger can optionally include mechanical or electrical components, or both. An exemplary ion exchanger is disposed within a substrate of the detoxification cartridge along with a monitoring device to determine the salt concentration. The normal salt concentration of the spent dialysis fluid should be approximately 0.8%. If the salt concentration of the spent dialysis fluid is less than 0.8%, the monitoring device maintains the ion exchanger in a closed configuration and fluid passes through the substrate to the next substrate. If the salt concentration in the spent dialysis fluid is more than approximately 0.8%, the monitoring device causes the ion exchanger to receive the spent dialysis fluid and remove salt such that the salt concentration of fluid leaving the ion exchanger is approximately 0.8%. Ion exchange resins suitable for use in the ion exchange chamber of the detoxification cartridge of the present invention include, but are not limited to, anionic resins (chloromethylated, aminated) or cationic resins (sulfonated or polycarboxylated resins).

In an embodiment of the detoxification cartridge of the present invention, a substrate contains hollow fiber or membrane filters for removal of middle molecular weight toxins including, but not limited to, molecules with a molecular weight of less than 50,000 daltons such as β-microglobulin, inulin, myoglobin and prolactin. On one side of the filter is a matrix which reacts with middle molecular weight toxins and creates the gradient which acts to pull middle molecular weight toxin molecules across the filter and keeps the gradient operable in one direction only. Matrices suitable for use with membrane or hollow fiber filters to remove middle molecular weight toxins include, but are not limited to, polyaldehydes such as oxidized starch and polyanhydrides such as glyoxal polymers, maleic and succinic anhydride copolymers and olefin copolymers.

In another embodiment of the recirculating dialysis apparatus of the present invention, an optional water removal device is disposed within the circuit either before or after the detoxification cartridge to maintain water balance in the dialysis fluid. The water removal device is comprised of a highly-absorbant material that absorbs water from the spent dialysis fluid.

In another embodiment of the recirculating dialysis apparatus of the present invention, an in-line sterilization filter is disposed in the system such that detoxified dialysis fluid passes through the sterilization filter immediately before it is returned to the second chamber of the dialysis cassette. Sterilization filters suitable for use with the extracorporeal renal dialysis system of the present invention include commercially available filters that are biocompatible and approved for use in patients. Preferable the sterilization filter will exclude particles having a size greater than 0.2 microns.

For peritoneal dialysis, dialysate is infused through an implanted infusion catheter at an access location in the abdomen wall, held in the peritoneal cavity for a period of time and then drained from an implanted drain catheter at the same access location. Infusion and drainage catheters are well known in the art and the components of the present invention are adapted for use with these standard catheters.

In one embodiment of the extracorporeal renal dialysis system of the present invention useful for a patient undergoing peritoneal dialysis, dialysate is infused by percutaneously introducing an access tube, typically a needle, cannula/stylet or other conventional coupling element to an implanted port in the peritoneal wall attached to the infusion catheter. The dialysate is then introduced at a positive pressure through the access tube and into the peritoneum. The positive pressure is established by gravity flow or alternatively by using an external pump. Dialysate is drained from the peritoneal cavity through the same access port. Usually the access tube for both infusion and draining will be the same but it is also possible to exchange different access tubes to the same implanted access port.

Spent peritoneal dialysate travels from the peritoneal cavity though tubing to the recirculating dialysis apparatus. Flow of fluid through the recirculating dialysis apparatus is unidirectional.

For hemodialysis, the blood is accessed through the first lumen of a dual lumen venous/venous or venous/arterial catheter, and detoxified blood is returned to the patient through the second lumen.

A particular advantage of the peritoneal dialysis system of the present invention is that it can be used in locations where a large and continuous supply of sterile dialysis fluid is not available. Dialysis fluid is normally purchased commercially ready made in multi-liter quantities or can be prepared by the patient by adding sterile water to bags containing powdered dialysate. In situations where sterile dialysate or water is not available, the toxin removal device of the present invention can be used to pre-treat tap water by passing tap water through the toxin removal device, filtering said detoxified water through the sterilization filter and collecting the sterile water in a sterile container, such as a sterile bag containing powdered dialysate. The detoxification cartridge can then be attached to the renal dialysis apparatus along with the sterile dialysate. Non-limiting examples of locations where the ability of the toxin removal device of the present invention to allow the production of sterile dialysate from tap water include any location away from a patient's home such vacation sites and locations where an acute trauma might occur such as a battlefield.

It is anticipated that a patient in need of dialysis will undergo at least one session per day with the extracorporeal renal dialysis system of the present invention or as prescribed by a medical professional such as a physician. In one embodiment of the present invention, the dialysis session would be performed at night while the patient is sleeping. For a patient undergoing peritoneal dialysis, in an exemplary embodiment, a volume of fresh dialysate, preferably one to two liters, is infused into the peritoneal cavity of a patient and the dialysate allowed to remain in the peritoneal cavity for a pre-determined period of time such as, but not limited to, one to three hours. For patients undergoing peritoneal dialysis, spent dialysate is the toxin-containing fluid. For patients undergoing hemodialysis, the blood is the toxin-containing fluid. The following process is the same for blood or peritoneal dialysate as the toxin-containing fluid.

The toxin-containing fluid is pumped from the patient by the recirculating dialysis apparatus into the first chamber of the dialysis cassette. Toxins in the toxin-containing fluid pass through the dialysis membrane into the dialysis fluid contained in the second chamber of the dialysis cassette by gradient diffusion. In one embodiment of the extracorporeal dialysis system of the present invention, the circuit comprising the second chamber of the dialysis cassette, the detoxification cartridge and associated tubing contains approximately one to ten liters of dialysis fluid, preferably one to two liters. The dialysis fluid from the second chamber of the dialysis cassette is then detoxified by passing the dialysis fluid through the detoxification cartridge(s) and the detoxified dialysate is returned to the second chamber of the dialysis cassette. The blood or spent peritoneal dialysate in the first chamber of the dialysis cassette has been detoxified and it returned to the patient. The toxin-containing fluid can be cycled through the extracorporeal renal dialysis system of the present invention in this manner for a pre-determined period of time, typically one to eight hours, before the system is disconnected from the patient and the used detoxification cartridge, dialysis cassette, water removal cartridge, sterilization filter and tubing and connections are discarded. In another embodiment of the present invention, the dialysate is not recirculated and the recirculating dialysis apparatus is used for one-pass dialysis.

In a non-limiting example of the extracorporeal renal dialysis system of the present invention, it is anticipated that an optional water removal cassette would be included in the dialysis system on an occasional basis, such as once every three to four days to remove excess water and recalibrate glucose levels.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. An extracorporeal renal dialysis system comprising a recirculating dialysis apparatus and at least one detoxification cartridge.

2. The extracorporeal renal dialysis system of claim 1 wherein said dialysis is peritoneal dialysis or hemodialysis.

3. The extracorporeal renal dialysis system of claim 1 wherein said recirculating dialysis apparatus can provide one-pass dialysis or recirculating dialysis.

4. The extracorporeal renal dialysis system of claim 1 wherein said recirculating dialysis apparatus comprises a device for regulating the flow of a fluid in need of toxin removal from a renal dialysis patient, through a dialysis cassette and returning said fluid to said renal dialysis patient.

5. The extracorporeal renal dialysis system of claim 4 wherein said dialysis cassette comprises a first chamber and a second chamber, wherein said first chamber and said second chamber are separated by a dialysis membrane.

6. The extracorporeal renal dialysis system of claim 5 wherein said dialysis membrane has a molecular weight cut-off of approximately 1,000 daltons to approximately 100,000 daltons.

7. The extracorporeal renal dialysis system of claim 5 wherein said second chamber contains dialysis fluid.

8. The extracorporeal renal dialysis system of claim 5 wherein said first chamber comprises a first port for fluid in need of detoxification to pass from said patient into said first chamber of said dialysis cassette and a second port for detoxified fluid to pass from said first chamber of said dialysis cassette to said patient.

9. The extracorporeal renal dialysis system of claim of claim 5 wherein said second chamber comprises a first port for spent dialysis fluid to pass from said second chamber of said dialysis cassette to said detoxification cartridge and a second port for regenerated dialysis fluid to pass from said detoxification cartridge into said second chamber of said dialysis cassette.

10. The extracorporeal renal dialysis system of claim 1 wherein said detoxification cartridge comprises at least one substrate containing at least one toxin-removal material selected from the group consisting of cross-linked micro- or macro-porous matrices, activated carbon, phosphate binding agents, ion exchangers, hollow fiber filters and membrane filters.

11. The extracorporeal renal dialysis system of claim 1 wherein the flow of fluid through said dialysis cassette and said detoxification cartridge is one-way.

12. The extracorporeal renal dialysis system of claim 1 further comprising a water removal cassette.

13. A recirculating dialysis apparatus comprising:
at least one pump;
at least one flow regulator;
at least one leak detector;
at least one pressure regulator;
at least one connecting port for attaching a dialysis cassette;
a heating system to maintain a constant temperature of toxin-containing fluids and dialysate;
a pH regulating system;
an in-line sterilization system;
a microprocessor;
a communication system to link said microprocessor with a healthcare professional;
a detoxification cartridge loading system; and
a cartridge port sterilizing system.

14. The recirculating dialysis apparatus of claim 13 wherein said apparatus further comprises a detoxification cartridge.

15. The recirculating dialysis apparatus of claim 13 wherein said cartridge port sterilization system comprises an ultraviolet light to terminally sterilize the engaged cartridge ports.

16. The recirculating dialysis apparatus of claim 13 wherein said microprocessor monitors the performance of said renal dialysis apparatus and generates performance data.

17. The recirculating dialysis apparatus of claim 13 wherein said microprocessor transmits said performance data to a remote site.

18. The recirculating dialysis apparatus of claim 14 wherein said recirculating dialysis apparatus releasably engages at least one detoxification cartridge at a sterile cartridge port.

19. The recirculating dialysis apparatus of claim 13 wherein said recirculating dialysis apparatus can provide one-pass dialysis or recirculating dialysis.

20. The recirculating dialysis apparatus of claim 13 further comprising an optional water removal device.

21. A detoxification cartridge comprising:
at least two ports suitable for aseptically and releasably connecting said detoxification cartridge to a recirculating dialysis apparatus; and
at least one substrate.

22. The detoxification cartridge of claim 21 wherein said at least one substrate comprises at least one toxin-removal material selected from the group consisting of cross-linked micro- or macro-porous matrices, activated carbon, phosphate binding agents, ion exchangers, hollow fiber filters and membrane filters.

23. The detoxification cartridge of claim 22 wherein said cross-linked micro- or macroporous matrix is cross-linked gelatin or a synthetic polymer grafted with albumin.

24. The detoxification cartridge of claim 22 wherein said phosphate binding agent is selected from the group consisting of calcium carbonate, lanthanum carbonate, zirconium hydroxide and hydrated oxides of iron or aluminum.

25. The detoxification cartridge of claim 22 wherein said ion exchanger for the removal of excess salt is comprised of an ion exchange resin contained within a permeable membrane wherein contact between said ion exchange resin and spent dialysate is allowed only when the concentration of salt in said spent dialysate is more than 0.8%.

26. The detoxification cartridge of claim 22 wherein said hollow fiber filter or said membrane filter has a molecular weight cutoff of less than approximately 50,000 daltons for the removal of middle molecular weight toxins.

27. The detoxification cartridge of claim 22 wherein said hollow fiber filter or membrane filter contains a polyaldehyde or a polyanhydride.

28. The detoxification cartridge of claim 27 wherein said polyaldehyde is oxidized starch.

29. A method of reducing dialysate usage in renal dialysis, wherein said method defines one dialysis session, comprising:
circulating fluid in need of toxin removal from a renal dialysis patient through a first chamber of a dialysis cassette and back to said patient;
allowing toxins from said fluid in need of toxin removal to pass through a dialysis membrane from said first chamber into a second chamber of said dialysis cassette, wherein said second chamber contains dialysis fluid;
passing said dialysis fluid through a detoxification cartridge;
detoxifying said dialysis fluid; and
returning said fluid to said second chamber of said dialysis cassette.

30. The method of claim 29 wherein said renal dialysis is peritoneal dialysis or hemodialysis.

31. The method of claim 29 wherein said fluid in need of toxin removal is dialysate or blood.

32. The method of claim 29 wherein the usage of fresh dialysis fluid is approximately one liter to approximately ten liters per dialysis session.

33. A method of removing toxins from a patient undergoing renal dialysis comprising:
reacting a toxin-containing fluid from said patient with at least one substrate containing a material which removes a toxin from said fluid; and
returning the toxin-depleted fluid to said patient.

34. The method of removing toxins from a patient according to claim 33 wherein said toxin-containing fluid is blood or dialysate.

35. The method of removing toxins from a patient according to claim 33 wherein said toxin is phosphate and said material is a phosphate binding agent selected from the group consisting of calcium carbonate, lanthanum carbonate, zirconium hydroxide and hydrated oxide of iron or aluminum.

36. The method of removing toxins from a patient according to claim 33 wherein said toxins are middle molecular weight toxins and said material is a hollow fiber filter or membrane filter.

37. The method of removing toxins from a patient according to claim 36 wherein said hollow fiber filter or membrane filter has a molecular weight cutoff of less than approximately 50,000 daltons for the removal of middle molecular weight toxins.

38. The method of removing toxins from a patient according to claim 36 wherein said hollow fiber filter or membrane filter contains a polyaldehyde or a polyanhydride.

39. The method of removing toxins from a patient according to claim 38 wherein said polyaldehyde is oxidized starch.

40. The method of removing toxins from a patient according to claim 33 wherein said toxin is a protein-bound toxin and said material is a cross-linked micro- or macroporous matrix selected from the group consisting of cross-linked gelatin or a synthetic polymer grafted with albumin.
